(19) United States
(12) Patent Application Publication
(10) Pub. No.: US 2009/0049035 A1
(43) Pub. Date: Feb. 19, 2009

(54) System and method for indexing type-annotated web documents

(75) Inventors: Hao He, Mountain View, CA (US); Haixun Wang, Irvington, NY (US); Philip Shilung Yu, Chappaqua, NY (US)

Correspondence Address: HARRINGTON & SMITH, PC, 4 RESEARCH DRIVE, Suite 202, SHELTON, CT, 06484-6212, US

(73) Assignee: International Business Machines Corporation

(21) Appl. No.: 11/891,921

(22) Filed: Aug. 14, 2007

(51) Int. Cl. G06F 7/06; G06F 17/30

(52) U.S. Cl. 707/5; 707/E17.017

(57) ABSTRACT

Methods and apparatus generate an index for use in a document retrieval system where the index is organized by type and keyword. Redundancy in the index is reduced by organizing type entries in a hierarchy of internal and leaf nodes. Determining whether to generate an inverted list for a type is based on the position of the type in the hierarchy; generally inverted lists are generated only for types corresponding to leaf nodes. Redundancy is further reduced by re-using inverted lists generated for keywords for types when there is an overlap between keywords and types. Search performance using the document retrieval index is improved by adding entries corresponding to combinations of keywords and types. The intersections of inverted lists associated with the keywords and types comprising the combinations are determined and added to the index for use in search operations. Determining whether to add an entry for a keyword-type combination is made on a cost-benefit analysis dependent, at least in part, on the proximity of the keyword to type in documents containing the combination.

### TECHNICAL FIELD

The invention generally concerns apparatus and methods for creating a type and keyword index for use in a document retrieval system, and more particularly concerns creating a type and keyword index for use in a document retrieval system that reduces redundancy by organizing type entries in a hierarchy and by reusing inverted lists created for keywords where there are overlaps between keywords and types.

### BACKGROUND

Document retrieval systems form an essential part of online search engines. Document retrieval systems typically incorporate apparatus for specifying search topics. Users are often frustrated by conventional search specification apparatus because searches generated with such conventional search specification apparatus often turn up many irrelevant documents that are of little interest to the user.

Accordingly, efforts have been made to improve search argument specification. One such improvement concerns combined keyword-and-type searches. Keyword searches are familiar to users. In a keyword search, a user enters keywords like “New York” and documents containing the keywords “New York” are returned. Since “New York” encompasses both a city and state, such a keyword search will return many “document hits” that are of little interest to a user who may be interested either in New York City or in New York State, but not both.

In response to this limitation of keyword searches, type searches have been proposed. Type searches add a “type” criterion that helps to limit a search criterion to a particular category. For example, a user may not be interested in New York State, but may be interested in New York City and environs. Accordingly, by adding a type hierarchy that allows a user to specify governmental and regional entities, a user can narrow a search by merely adding a “type” entry. For example, type entries can be made available corresponding to “city”, “metropolitan area” and “state”. With such “type” entries available, a user can specify a search “New York” and “Metropolitan Area”. Such a search argument will presumably return documents concerning the New York City Metropolitan Area.

Users familiar with document retrieval systems realize that search arguments which may appear likely to find relevant documents often turn up many irrelevant documents. For example, in the above search argument “New York” and “Metropolitan Area” may turn up documents that concern the Buffalo and Albany Metropolitan Areas.

Search argument specification has evolved to combat this problem by allowing users to specify searches in terms of proximity. For example, a search argument may be specified as “New York” within ten words of “Metropolitan Area”. Specifying a search argument in such a manner makes it more likely that “Metropolitan Area” will be used with reference to “New York” and not some other city in New York State like Buffalo or Albany.

Although such proximity-based search arguments are useful in overcoming the limitations of earlier types of search arguments, they create their own problems. In addition, more general problems have been encountered in type-capable document retrieval systems. The problems generally concern so-called “inverted lists” that are used to identify documents responsive to search arguments. An inverted list or inverted index (the two terms are used interchangeably herein) is the opposite of a typical book index. In a book index, an index entry identifies where in the book the indexed topic appears. In contrast, an inverted list or index identifies which documents contain or concern the indexed term.

Accordingly, to make an index system that will be responsive to a wide range of queries, many such inverted lists have to be created. Since it is not enough to merely create the lists since the lists have to be available when search arguments are received, the lists must be stored. The storage requirements may make such document retrieval systems particularly expensive and possibly impractical.

An additional factor further complicates the situation. Unlike keywords which are typically stand-alone and do not relate to one another, type categories often can be related to one another. For example, type categories often form hierarchies that can be represented by so-called “directed acyclic graphs” (“DAGs”). Referring back to the New York example, type categories relating to governmental entities can be arranged in a hierarchy of state-county-city-borough. The indexing associated with such hierarchies will be even more burdensome then that associated with keywords.

Further, since inverted lists have to be created for proximity searches combining types and keywords, this adds a further complication.

Accordingly, those skilled in the art seek methods and apparatus that overcome the problems associated with indexes for use in document retrieval systems.

### SUMMARY OF THE INVENTION

An embodiment of the invention is a method. The method establishes a document retrieval index for use in a document retrieval system wherein the document retrieval index is organized by type and keyword entries. The method first organizes type entries by a type hierarchy comprising internal and leaf nodes. The method next determines whether to generate an inverted list for particular types in the type hierarchy mapping the types to documents including the types in dependence on the position of the types in the type hierarchy. The method then generates an inverted list for at least some of the types in the type hierarchy as a result of the determination.

Another embodiment of the invention is a computer program product. The computer program product tangibly embodies a computer program in a computer readable memory medium. The computer program tangibly embodied in the computer readable memory medium is configured to perform operations involving a document retrieval index when executed by digital processing apparatus. The operations performed by the computer program when executed comprise: establishing the document retrieval index, where the document retrieval index is organized by type and keyword entries; organizing type entries by a type hierarchy comprised of internal and leaf nodes; determining whether to generate an inverted list for particular types in the type hierarchy in dependence on the position of the types in the type hierarchy, wherein the inverted list maps the types to documents including the types; and generating an inverted list for at least some of the types in the type hierarchy as a result of the determination.

A further embodiment of the invention is a system comprising at least one computer memory and a processing apparatus. The at least one computer memory is configured to store a computer program and a document retrieval index. The computer program is configured to perform operations involving the document retrieval index when executed by the processing apparatus. The processing apparatus is coupled to the at least one computer memory. When the computer program is executed by the processing apparatus the system is configured to organize the document retrieval index by type and keyword entries; to organize the type entries by a type hierarchy comprising internal and leaf nodes; to determine whether to generate an inverted list for particular types depending on the position of the types in the type hierarchy; and to generate an inverted list for at least some of the types in the type hierarchy as a result of the determination.

In conclusion, the foregoing summary of the various embodiments of the present invention is exemplary and non-limiting. For example, one of ordinary skill in the art will understand that one or more aspects or steps from one embodiment can be combined with one or more aspects or steps from another embodiment to create a new embodiment within the scope of the present invention.

### BRIEF DESCRIPTION OF THE DRAWINGS

The foregoing and other aspects of these teachings are made more evident in the following Detailed Description of the Invention, when read in conjunction with the attached Drawing Figures, wherein:

FIG. 1 is a block diagram depicting a system in which embodiments of the invention may be practiced;

FIG. 2 is a flowchart depicting a method operating in accordance with the invention;

FIG. 3 is a flowchart depicting another method operating in accordance with the invention; and

FIG. 4 is a flowchart depicting a further method operating in accordance with the invention.

### DETAILED DESCRIPTION OF THE INVENTION

Embodiments of the invention comprise a space-efficient type and keyword index for use in a document retrieval system supporting proximity searches. Space-efficient type and keyword indexes organized in accordance with the invention reduce storage redundancy without significantly degrading query performance.

A type and keyword index organized and generated in accordance with the invention can be used to service search queries sent by users to document retrieval systems. Queries that benefit from the type and keyword index of the invention generally fall into two categories: type queries and combined type and keyword queries. The following discussion seeks to draw a distinction between what is meant by “type” and what is meant by “keyword”. This discussion is exemplary and exceptions to the general description may be found. Type queries often refer to queries that are specified in terms of, for example, a common noun. Common nouns do not refer to a specific entity, but rather to a class of entities. This is exemplified by the preceding discussion regarding governmental entities, where country, state and city are each examples of“types”. In addition, as described above, “types” often can be related to one another in a hierarchy. Keywords, in contrast, often refer to specific entities. A search query “borough” is an example of a type query. A search query “borough and New York City” is an example of a combined type and keyword query.

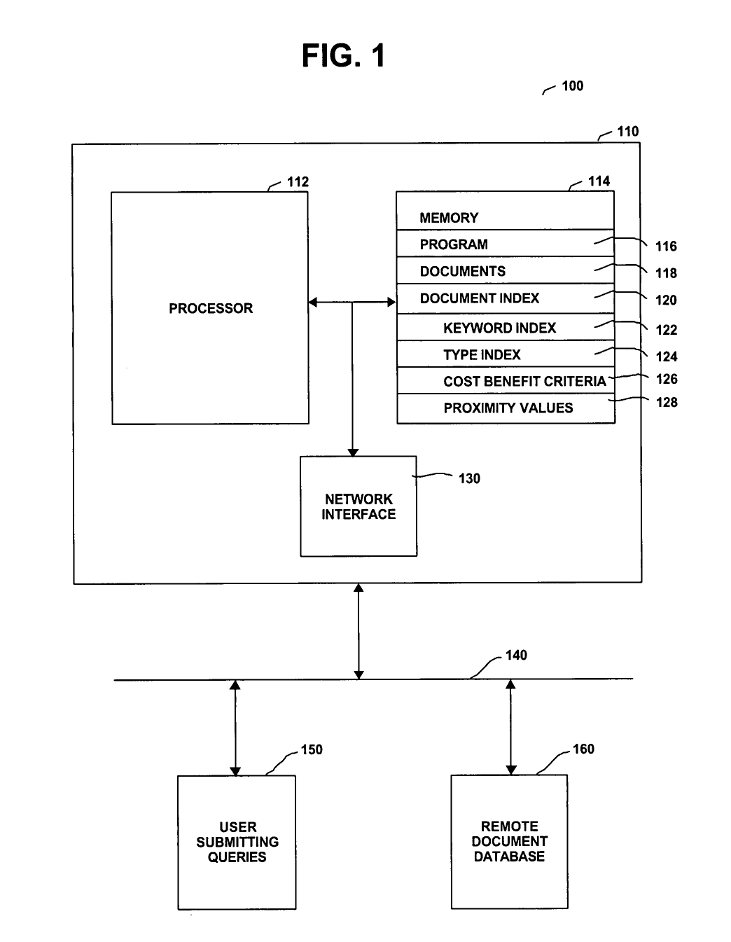

Before proceeding with a description of the methods of the invention, a system operating in accordance with the invention will be described. FIG. 1 is a block diagram depicting such a system 100. The system comprises a server 110; a network 140; a user submitting queries 150; and a remote document database 160.

The server 110 comprises a processor 112 configured to execute programs that operate in accordance with methods of the invention; memory 114; and a network interface 130. Although implemented in a server in the system 110, aspects of the invention may be implemented in other ways. For example, aspects of the invention may be implemented in a stand-alone computer system. Although one processor is depicted in FIG. 1, more than one processor may be used. In fact, numerous computing apparatus including single-core processors; multi-core processors; multi-processor severs; and distributed processing networks as exemplary and non-limiting examples may be used to practice the invention. Similar remarks apply to the memory 114 depicted in FIG. 1. Although one collective memory is depicted in FIG. 1, programs executed and information used and created during practice of methods of the invention may be distributed across several or more memory apparatus including hard drives; CD- or DVD-ROM; flash memory; RAM memory, etc.

In any case, as will become more clear as the present description proceeds, the exemplary memory 114 stores at least one computer program 116; documents 118 to be indexed and searched; and a document index 120. The document index further comprises keyword 122 and type 124 indexes and related information used in creating the indexes including cost-benefit criteria 126 and proximity values 128. The at least one computer program 116 typically comprises several or more computer programs that perform different functions in accordance with methods of the invention. Typical divisions between computer programs operating in accordance with the invention occur between programs that perform pre-document-query-receipt index creation and programs that create indexes to be used in document searches performed in response to receipt of document search queries.

Server 110 further comprises a network interface 130 for managing communications over network 140. Although the server depicted in FIG. 1 is configured to perform indexing and search operations on self-stored documents 118, the server is also capable of performing indexing and search operations in a networked environment involving, for example, documents stored in remote database 160.

Network interface 130 is also configured to receive requests from users 150 submitting queries over network 140, and to return search results over network 140.

Following the foregoing description of a system incorporating aspects of the invention, methods of the invention will now be described. Space-efficient type and keyword indexes organized in accordance with the invention exploit relationships between types, and between types and keywords. Types comprising a group of types in a larger collection of types often can be related to one another in a hierarchical relationship that resembles a family tree. As an instance of a fine or child type t in such a hierarchy is also an instance of all of t's ancestor or parent types, an inverted list needs to be materialized only for the finest types in the type hierarchy. In the words of graph theory, inverted lists need only be materialized for types corresponding to leaf nodes in a DAG representing the type hierarchy. As indicated, the invention also exploits relationships between types and keywords. As a keyword entry may overlap or even coincide with a type, entries in a type and keyword index corresponding to keyword instances can be reused in the type portion of the index to the extent that there is overlap between the keyword instances and the type instances.

In embodiments of the invention a “keyword-type index” (or KT-index) is generated. A keyword-type index stores intersections of inverted lists for selected types and keywords. Embodiments of the invention create such keyword-type indexes in an efficient manner with a view toward optimizing use of storage resources. The keyword-type index comprises many neighboring lists where each list uses a keyword and type pair (k,t) as its key. Conceptually, the list for (k,t) stores the common document identifiers in which “k” and “t” appear together within a pre-determined distance. In other words, the inverted list for a (k, t) pair list documents in which the keyword and type occur together.

Since the cost of materializing all possible (k,t) pairs will be prohibitive, in an embodiment of the invention a cost model is used to measure the benefit and cost associated with materializing inverted lists for (k,t) pairs. Using this approach, only pairs meeting a predetermined cost/benefit criterion are materialized. In one embodiment, only the most profitable pairs are materialized.

Accordingly, in a type and keyword index organized in accordance with the invention, the type index portion utilizes existing keyword portions of the index and therefore significantly reduces the required storage space, avoiding the redundancy introduced by previous work. A keyword and type index organized in accordance with the invention also improves query evaluation performance significantly. Given a query q={K,T} where T={T₁, . . . , Tᵢ} are types and K={K₁, . . . , Kⱼ} are keywords, for each list of (k,t) in the keyword and type index where k is in K and t is in T, the list can be used to join with other lists and avoid loading and scanning the inverted list of t, which maybe long, as well as the other list of k. Even if only part of sub-types is indexed, the part will be re-utilized when available to avoid redundancy. A keyword and type index organized in accordance with the invention is also flexible to update. Since each (k, t) list is stand-alone, the update of a keyword-type index in accordance with the invention is straightforward and does not involve global updates.

A first aspect of the invention concerns a type index (denoted as I_{T}). Since an instance of a fine type t is also an instance of all t's ancestor types, only the inverted lists for the finest types (leaf nodes in A) need to be materialized. Then the inverted list of any type can be restored by retrieving inverted lists for all of the finest types, which are its descendants. Thus, for a non-leaf type, the type index only needs to store its child types, without materializing all occurrences of this type. Thus, a type index organized in accordance with this aspect of the invention avoids storage redundancy.

Embodiments of the invention further reduce the storage space required for the inverted lists of leaf nodes. As indicated previously, this aspect of the invention exploits the availability of a keyword index. As the keyword index has stored all keyword instances that overlap with most type instances, certain entries in the keyword index are re-used in the type index.

Next, different types of annotations on a keyword in a collection of documents will be discussed. A keyword k is always annotated with the same type t. In embodiments of the invention a pointer to k's list is stored in t's inverted list, instead of storing all occurrences of k again. In many cases, a type actually corresponds to a set of such keywords, whose inverted lists have already been materialized. Thus the inverted list for this type is created by storing references to these keywords in the inverted list of the type. The inverted list for the type is materialized at query time by aggregating the inverted list of keywords to which it contains references. Again, this avoids redundancy since the inverted list for the keywords are not recreated and stored with reference to the type.

In another aspect of the invention, a keyword k is annotated as more than one but a very limited number of types. This aspect of the invention avoids redundancy by breaking k's inverted list into several segments clustered by annotated types. The inverted list of each annotated type contains a pointer pointing to the corresponding segment in k's list. After k's list is clustered in segments according to types, scanning this list will be a little different since the whole list will not be monotonically sorted by document ID. When k's list needs to be scanned and the intersection with other lists determined, multiple iterators will be needed to scan each segment in parallel.

In a further aspect of the invention a keyword k can be annotated with many types in different occurrences. The approach of partitioning k's list by types may result in too many iterators during scanning. Thus a tradeoff between storing these occurrences and reusing the keyword list will be considered.

In yet another aspect of the invention, a keyword k is annotated with a type that is not in the keyword index. For example, some words are stop words or numbers, which are not indexed usually. A type list has to be constructed for them.

As is apparent from the above discussion, the availability of a keyword index is fully utilized and a complete type index can be acquired with minimal storage cost. So an inverted list for a type may consist of several parts: all child types (non-leaf nodes); a set of pointers to corresponding positions in keywords' lists; postings of its occurrences as the traditional inverted list. With the new type index, query performance is not sacrificed due to “upcasting”.

Given the type index, it can be treated in the same manner as a traditional keyword index for search. A type+keyword query can be simply processed using following steps:

(1) Load each query keyword or type list.

(2) Scan these lists in parallel and identify their intersection (common documents) as candidates.

(3) Compute the score for each candidate and rank.

Note that with a free text query interface, users are not required to know the structure of the type hierarchy. It is very likely that the type predicate in a query contains general types, instead of the finest possible types in the hierarchy. For example, a user tends to issue a query like “[person] solve Poincare conjecture” rather than “[mathematician] solve Poincare conjecture”. As a general type t may be expanded to many finer subtypes, each of which may further correspond to many keywords, the total occurrence of t's instances and, accordingly, the size of t's inverted list, is probably much larger than that of a keyword. Therefore, even if the complete type index exists, loading the inverted lists of query types may dominate query processing time. As a result, the performance of a search engine supporting type predicate may be much worse than that of traditional search engines.

Next to be described is a keyword-type index generated and organized in accordance with apparatus and methods of the invention. A proximity search requires that more attention be paid to postings within a short distance. In response to this observation, a keyword-type index operating in accordance with the invention indexes co-occurrences of keywords and types in the same document using a proximity measure. This improves the query evaluation performance as it maintains the intersection of keywords and types. Thus, at query time when a query is received that is searching for documents that contain a particular type and a particular keyword, only an inverted list representing the joint result of the particular type and particular keyword need be loaded. This avoids the necessity of accessing the remaining parts of the inverted lists for the particular type and particular keyword that do not overlap.

The keyword-type index of the invention comprises many neighboring lists where each list uses a keyword and type pair (k, t) as its key. Conceptually, the list for (k, t) stores the common document identifiers indicating the documents that contain both k and t, that is, their joint result. However, storing all possible joint results will be prohibitively expensive in terms of memory storage space. Thus several approaches are adopted in aspects of the invention to improve storage efficiency.

In a first approach applied in embodiments of the invention, a proximity measure is adopted. In one embodiment, the appearance of a keyword and a type is counted as a co-occurrence only if the keyword and type appear within a pre-determined distance (proximity measure) of one another. The pre-determined proximity measure can be likened to a window. In this embodiment if the keyword and type are separated by a distance greater than or equal to the pre-determined proximity measure, then the document is not counted as a co-occurrence and is not included in the inverted list corresponding to the joint result for the keyword and type. As in a keyword search, if two query keywords appear in the same document, but are far away from each other, this document probably ranks low as a meaningful response to the query. So in a proximity-based search operating in accordance with this aspect of the invention more attention is paid to documents where co-occurrences involve keywords and types that are close to one another. In this aspect of the invention, a list for (k, t) stores the common documents where k and t appear together within a pre-determined window.

In a second approach applied in embodiments of the invention concerning keyword-type indexes, document identifiers are stored instead of detailed positions. This approach makes the list shorter and therefore saves memory storage space. Exact position information is only needed when computing the score of a document. The goal of using a keyword-type index is to facilitate quick retrieval of document candidates. Using a proximity measure means only documents like to be responsive to a query will be returned. So computing ranks can be done after identifying responsive documents.

In a third approach applied in aspects of the invention, keyword-type indexes are constructed only for parts of individual types. Choosing to construct keyword-type indexes only for parts of types often achieves much of the benefit without unduly increasing storage requirements.

Keyword-type indexes generated and organized in accordance with the invention can improve query evaluation performance. Given a query q={T, K} where T={t₁, . . . , tᵢ} are types and K={k₁, . . . , kᵢ} are keywords, for each list of (k,t) in the keyword-type index where k ∈ K and t ∈ T, this list can be joined with other lists to avoid loading and scanning the inverted list of t, which typically may be long, as well as the list of k.

A keyword-type index generated and organized in accordance with the invention has several desirable properties. First, the keyword-type index can be flexibly updated. Since each (k,t) list is stand-alone and which k and t to materialize can be chosen, the update of a keyword-type index is straightforward and does not require global updates. Second, the keyword-type index can store statistical information for (k,t) pairs, even for those that are not materialized. Such information can be used to determine selectivity during query time.

Next, how to choose types to materialize in accordance with methods of the invention will be described. The storage cost of maintaining all joint results of possible keyword and type pairs into a keyword-type index is prohibitive. Suppose the window size is w. For a type t, in the worst case the size of all (k,t) lists would be w-fold of the size of t's inverted list. Obviously, the materialized percentage of the keyword-type index introduces a tradeoff between storage cost and query speedup. Given a space budget the most profitable (k,t) pairs should be selected to be materialized. The selection of types to be materialized will now be described.

First, a cost model is constructed to measure benefit and cost. The query speedup provided by a keyword-type index is considered as a benefit, which is formally defined as follows.

Definition 1 (Benefit of a (k,t) list). Assume t's inverted list is denoted as I_{T}(t), k's inverted list is denoted as I_{K}(k) and the (k,t) list in KT-index is I_{KT}(k, t). The benefit of a (k,t) list is defined as:

|I_{T}(t)|+|I_{K}(k)|−|I_{KT}(k, t)|

When a query contains k and t, either I_{T}(t) (without I_{KT}(k, t) in the keyword-type index) or I_{KT}(k, t) needs to be loaded. Since the I/O time and scanning time are both in proportion to the list length, the speedup is defined as a benefit.

The overall benefit needs to consider the probability of a type in query workload. It is defined as follows.

Definition 2 (Benefit of a keyword-type index). Assume the probability that a type t and a keyword k are queried together is P(k,t). The benefit of a keyword-type index is defined as:

$$Benefit = {\sum }_{( k , t ) ∈ {I}_{KT}} P ( k , t ) ( \vert {I}_{T} ( t ) \vert + \vert {I}_{K} ( k ) \vert - \vert {I}_{KT} ( k , t ) \vert )$$

The space used to store the keyword-type index is defined as a “cost”, which is defined as:

Definition 3 (Cost of keyword-type index). The cost is defined as the total size of the keyword-type index:

$$Cost = {\sum }_{( k , t ) ∈ {I}_{KT}} \vert {I}_{KT} ( k , t ) \vert$$

Under this cost model, given a space budget, (k,t) pairs that maximize Benefit should be chosen. Next how to derive values needed in the model will be discussed. First, |I_{T}(t)| can be easily derived since the type index already exists. |I_{KT}(k,t)| can be acquired when the keyword index is created and this will be discussed in detail soon. P(k,t) can be estimated by complex model on a query workload. A simple way of estimating P(k,t) is now presented. This rough estimation can show the lower bound of the benefit of a keyword-type index.

Since types form a type hierarchy, the probability P(t) that a type t is queried can be computed through a query workload, even if t does not appear in this workload. Once a type t appears in a query of the workload, t is assigned a unit of weight. If t is not a leaf node, this weight will be evenly distributed to its descendants that are leaf nodes. Then P(t) will be estimated by the sum of the weight of all its leaf descendants.

However, the probability of a query containing a keyword cannot similarly be estimated with a small query workload. Instead, it is assumed that keywords are queried uniformly and it is also assumed that k and t are independent. Thus P(k,t)=P(t)/|K| where K is the keyword set.

Given the cost model, types can be sorted according to the benefit/cost ratio so that the most profitable types are materialized first. One way of estimating P(k,t) is to accumulate query history and dynamically adjust the keyword-type index according to the statistics up to the current workload, like a caching system.

Now to be discussed is how to derive |I_{KT}(k,t)| during the construction of the keyword and type index. A matrix M will be used to store the keyword-type co-occurrence information. Each entry m_{k,t} of M stores the number of documents in which k and t appear together. Note that m_{k,t}=|I_{KT}(k,t)|.

When a document is scanned during the construction of an index, a window around the current processed keyword is maintained and the types that occur within this window are recorded. As the window moves, new types occurring within the window are similarly recorded. Accordingly, m_{k,t} is increased for the current keyword k with each new type t in the window. Since the number of documents in the KT-index is the desired value, m_{k,t} is increased only once for a single document.

Batch Mode: Given the set of types R to materialize and annotated documents D, the keyword-type index can be constructed in batch. The following algorithm CreateIndex (R,D) is similar to the manner in which the co-occurrence matrix M was derived in the previous subsection.

### CreateIndex(R,D)

1: for each document d in D do
2: while it is not the end of d do
3: get the next keyword k
4: update the window w and the types T ∈ R inside w
5: for each type t in T
6: if I_{KT}(k,t) does not already contain d then
7: insert d into I_{KT}(k,t).

Single List: If only a (k,t) list needs to be built, the inverted lists of k and t are scanned and all of their co-occurrences are stored, just as in evaluating the query “k[t]”.

Search using a keyword-type index: A query “[t]k₁k₂” is evaluated in the following steps:
1: Expand t to a set of leaf types, which may or may not be indexed in the keyword-type index. Indexed types are denoted T₁ and un-indexed types T_{U}.
2: For each tᵢ in T₁, load I_{KT}(k₁,tᵢ) and I_{KT}(k₂,tᵢ), and compute their intersection to identify document candidates. Verify candidates.
3. For each tᵢ in T_{U}, load Iₜ(tᵢ). Load I_{K}(k₁) and I_{K}(k₂). Scan all lists in parallel to identify responsive documents.

The search algorithm demonstrates the advantages of a keyword-type index generated and organized in accordance with the invention. Even if only parts of subtypes are indexed, they can still be fully utilized.

There are several reasons why joint results are materialized for selected keywords and types. First, types are not stand-alone. Different from a keyword case where the cached intersection of two keywords' lists can only be used for queries containing these exact two keywords, the co-occurrence index for a keyword k and a type t can be used for the queries that contain any of t's ancestor types. Second, the number of types is much smaller than the number of keywords. Therefore, the chance of a keyword-type query containing a particular keyword is much higher than a keyword-only query containing a particular keyword.

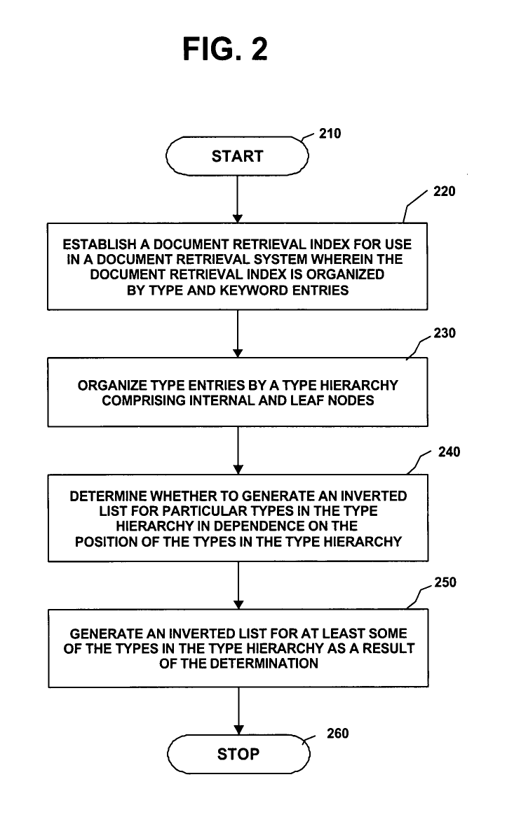

In summary, FIGS. 2-4 depict methods operating in accordance with the invention. FIG. 2 is a flow chart depicting a method operating in accordance with an embodiment of the invention wherein decisions whether to materialize an inverted index for a type entry is based, at least in part, on the position of the type entry in a type hierarchy. In an exemplary embodiment, the method may be practiced by a server 110 as depicted in FIG. 1. The method would be practiced when the processing apparatus 112 of server 110 executes a program 116 that performs steps of the method when executed. The method starts at 210. At 220, processor 112 executes program instructions that establish a document retrieval index for use in a document retrieval system maintained by server 110. The document retrieval index is organized by type and keyword entries. Next, processor 112 executes program instructions at 230 that organize type entries by a type hierarchy comprising internal and leaf nodes. Then, at 240, processor 112 executes program instructions that determine whether to generate inverted lists for particular types in the type hierarchy in dependence on the position of the types in the type hierarchy. Next, at 250, processor 112 executes program instructions that generate an inverted list for at least some of the types in the type hierarchy as a result of the determination. Then, at 260, the method stops.

In a variant of the method of the invention depicted in FIG. 2, when determining whether to materialize an inverted list for particular types and generating an inverted list for at least some of the types, processor 112 executes program instructions that generate inverted lists only for types corresponding to leaf nodes in the type hierarchy.

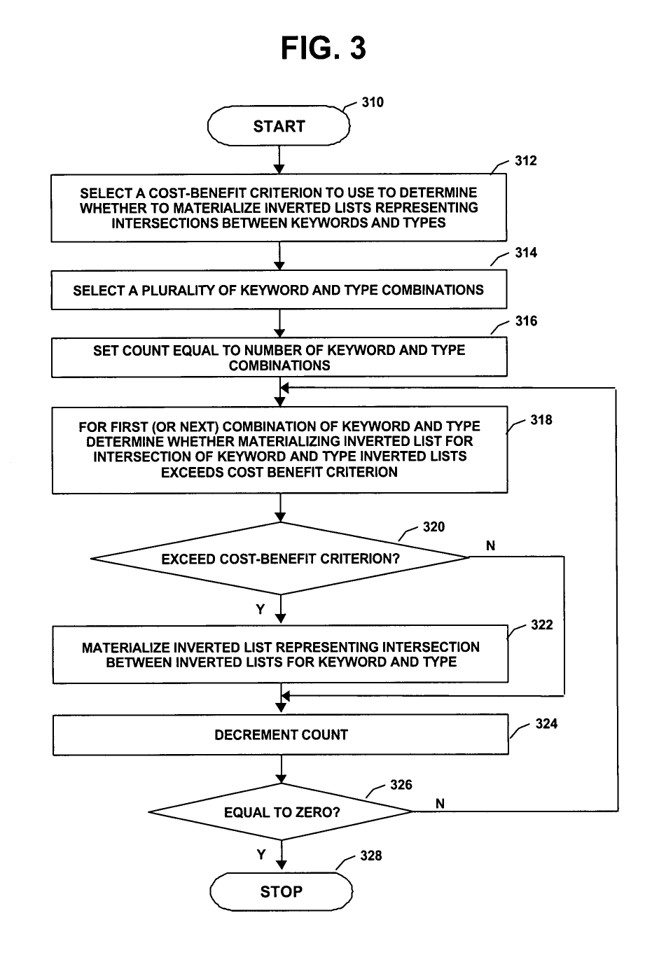

Another method operating in accordance with the invention is depicted in the flowchart of FIG. 3. The method depicted in FIG. 3 can be practiced alone or in combination with other methods of the invention described herein. As in the case of the method depicted in FIG. 2, the method may be practiced when the processing apparatus 112 of server 110 executes a program that performs the steps of the method when executed. The method starts at 310. Then, at 312 the processor 112 of server 110 executes program instructions that select a cost-benefit criterion to use to determine whether to materialize inverted lists. Next, at 314, the processor 112 of server 110 executes program instructions that select a plurality of keyword and type combinations. In alternate embodiments, the program instructions executed at 312 and 314 may be configured to receive, respectively, a cost-benefit criterion and a selection of keyword and type combinations from a human user when executed. Then, at 316 the processor sets a count equal to the number of keyword and type combinations. Next, at 318, the processor 112 executes program instructions that for a first (or next) combination of keyword and type determine whether materializing an inverted list for the intersection of the keyword and type inverted lists exceeds a cost benefit criterion. If materializing the inverted list for the intersection does exceed the cost-benefit criterion, then at decision diamond 320 the processor executes program instructions that continue to 322, where an inverted list representing the intersection between inverted lists for the keyword and type comprising the combination are materialized. “Materialize” generally means to generate the inverted list and save it to memory so that it is available when needed to respond to a user query. After materializing the inverted list for the intersection, the method continues at 324 where the processor 112 executes program instructions that decrement the count. If it is determined at 326 that the count is equal to zero, cost-benefit analyses have been performed for all the selected keyword and type combinations and the method stops at 328. If the count is not equal to zero, the processor 112 executes program instructions that return the method to 318, where a cost-benefit analysis is performed for the next keyword and type combination. Returning to the decision diamond 320, if it is determined that materializing an inverted list for a particular keyword and type combination does not exceed a cost-benefit criterion an inverted list representing the intersection of the keyword and type is not materialized and the method jumps to 324 to decrement the count. Again, if the count is determined to be equal to zero at decision diamond 326 the method stops at 328. If the count is not yet zero, the method returns to step 318 and performs a cost-benefit analysis for materializing an inverted list for the next combination of keyword and type.

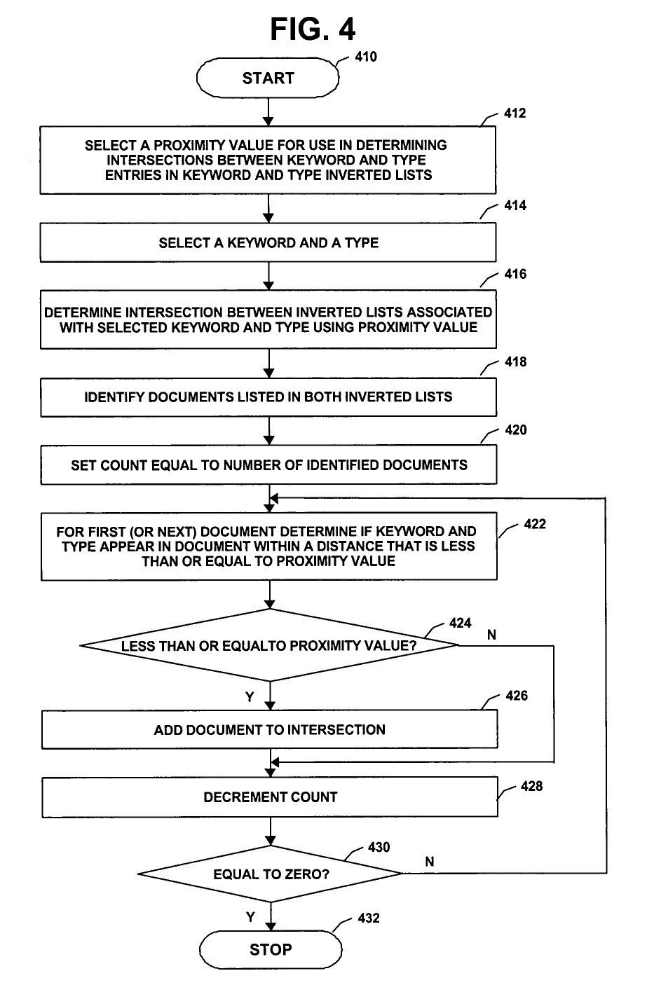

A further method operating in accordance with the invention is depicted in the flowchart of FIG. 4. The method depicted in FIG. 4 can be practiced alone or in combination with other methods of the invention described herein. As in the case of the method depicted in FIG. 3, the method may be practiced when the processing apparatus 112 of server 110 executes a program that performs the steps of the method when executed. The method starts at 410. At 412, processor 112 executes program instructions that select aproximity value for use in determining intersections between keyword and type entries in keyword and type inverted lists. Next, at 414, processor 112 executes program instructions that select a keyword and a type. In various embodiments, the operations performed at 412 and 414 may be automated; or alternatively, the program instructions may be configured to receive selections of the identified parameters from a human user when the program instructions are executed. Then, at 416, processor 112 executes program instructions that determine the intersection between the inverted lists associated with the selected keyword and type using the proximity value.

The next steps 418-430 in summary create an initial intersection where documents appearing in the inverted lists of both the keyword and type are identified. The documents in the initial intersection are added to the “final” intersection only if the type and keyword appear in the documents separated by a distance that is less than or equal to the proximity value. The proximity value specifies a “window” that is used to determine whether particular documents should be added to the final intersection.

The method continues at 418 where the processor 112 executes program instructions that identify a collection of documents that appear in the inverted lists of both the keyword and the type. Each document comprising the collection contains both the keyword and the type. This collection of documents comprises the “initial” intersection referred to above. Next, the processor 112 executes program instructions that set a count equal to the number of documents in the collection comprising the “initial” intersection. Then, at 422 for the first (or next) document of the collection, the processor executes program instructions that determine if the keyword and type appear in the document within a distance that is less than or equal to the proximity value. In other words, do the type and keyword appear simultaneously in the “window” specified by the proximity value? If so, the decision reached at decision diamond 424 is “Yes” and the document is added to the intersection (referred to as the “final” intersection above). Then processor 112 executes program instructions that decrement the count at 428. Another decision diamond is reached at 430. If the count is zero, the method stops at 432. If not, the method returns to 422 to examine the next document to determine whether it should be added to the intersection. If at 424 it is determined that the keyword and type do not appear simultaneously in the window (i.e., the keyword and type are separated by a distance greater than the proximity value) then the document is not added to the intersection, and the method jumps to 428 to decrement the count to determine if all the documents have been analyzed.

Thus it is seen that the foregoing description has provided by way of exemplary and non-limiting examples a full and informative description of the best apparatus and methods presently contemplated by the inventors for creating keyword-type indexes to be used in responding to document queries specifying proximity-based keyword and type search arguments. One skilled in the art will appreciate that various embodiments described herein can be practiced individually; in combination with one or more other embodiments described herein; or in combination with methods and apparatus differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

We claim:

1. A method comprising:
establishing a document retrieval index for use in a document retrieval system
wherein the document retrieval index is organized by type and keyword entries;
organizing type entries by a type hierarchy comprising internal and leaf nodes;
determining whether to generate an inverted list for particular types in the type hierarchy mapping the types to documents including the types in dependence on the position of the types in the type hierarchy; and
generating an inverted list for at least some of the types in the type hierarchy as a result of the determination.

2. The method of claim 1 wherein determining whether to materialize an inverted list for particular types and generating an inverted list for at least some of the types further comprise generating inverted lists only for types corresponding to leaf nodes in the type hierarchy.

3. The method of claim 2 further comprising:
determining overlaps between keywords and types; and
where there is an overlap between a keyword and a type that corresponds to a leaf node, using an inverted list associated with the keyword as the inverted list for the type.

4. The method of claim 1 further comprising:
selecting at least one combination of type and keyword;
for the type and keyword comprising the combination, determining an intersection between an inverted list associated with the type and an inverted list associated with the keyword; and
saving information describing the intersection.

5. The method of claim 1 further comprising:
selecting combinations of types and keywords;
sorting the combinations of types and keywords by a benefit/cost criterion;
determining which combinations of type and keyword exceed a benefit/cost criterion threshold;
for each combination of type and keyword determined to have benefit/cost criterion that exceeds a benefit/cost threshold:
determining an intersection between an inverted list associated with the type and an inverted list associated with the keyword; and
saving information describing the intersection.

6. The method of claim 1 further comprising:
selecting a proximity value, wherein the proximity value corresponds to a predetermined distance between words in a document;
selecting at least one combination of type and keyword;
determining an intersection between an inverted list associated with the type and an inverted list associated with the keyword using the proximity value, where a particular document appearing in inverted lists associated with both the type and keyword is included in the intersection only if the type and keyword appear together in the particular document separated by a distance less than or equal to the proximity value; and
saving information describing the intersection.

7. The method of claim 1 further comprising:
adding an entry in the types entries corresponding to each keyword; and
for each type entry corresponding to a keyword, adding a pointer to the inverted list associated with the keyword.

8. The method of claim 1 further comprising:
selecting a keyword, the keyword having an inverted list;
splitting the inverted list associated with the keyword into a plurality of segments;
associating each segment with a different type entry; and
for each type entry associated with a segment of the inverted list of the keyword, inserting a pointer to the segment.

9. A computer program product tangibly embodying a computer program in a computer readable memory medium, the computer program configured to perform operations involving a document retrieval index when executed by digital processing apparatus, the operations comprising: establishing the document retrieval index, where the document retrieval index is organized by type and keyword entries; organizing type entries by a type hierarchy comprised of internal and leaf nodes; determining whether to generate an inverted list for particular types in the type hierarchy in dependence on the position of the types in the type hierarchy, wherein the inverted list maps the types to documents including the types; and generating an inverted list for at least some of the types in the type hierarchy as a result of the determination.

10. The computer program product of claim 9 wherein determining whether to materialize an inverted list for particular types and generating an inverted list for at least some of the types further comprise generating inverted lists only for types corresponding to leaf nodes in the type hierarchy.

11. The computer program product of claim 10 wherein the operations further comprise: determining overlaps between keywords and types; and where there is an overlap between a keyword and type that corresponds to a leaf node, using an inverted list associated with the keyword as the inverted list for the type.

12. The computer program product of claim 9 wherein the operations further comprise: selecting at least one combination of type and keyword; determining an intersection between an inverted list associated with the type and an inverted list associated with the combination; and saving information describing the intersection.

13. The computer program product of claim 9 wherein the operations further comprise: selecting combinations of types and keywords; sorting the combinations of types and keywords by a benefit/cost criterion; determining which combinations of type and keyword exceed a benefit/cost criterion threshold; for each combination of type and keyword determined to have a benefit/cost criterion that exceeds a benefit/cost threshold: determining an intersection between an inverted list associated with the type and an inverted list associated with the keyword; and saving information describing the intersection.

14. The computer program product of claim 9 wherein the operations further comprise: selecting a proximity value, wherein the proximity value corresponds to a predetermined distance between words in a document; selecting at least one combination of type and keyword; determining an intersection between an inverted list associated with the type and an inverted list associated with the keyword using the proximity value, where a particular document appearing in inverted lists associated with both type and keyword is included in the intersection only if the type and keyword appear together in the particular document separated by a distance less than or equal to the proximity value; and saving information describing the intersection.

15. The computer program product of claim 9 wherein the operations further comprise: adding an entry in the type entries corresponding to each keyword; and for each type entry corresponding to a keyword, adding a pointer to the inverted list associated with the keyword.

16. The computer program product of claim 9 wherein the operations further comprise: selecting a keyword, the keyword having an inverted list; splitting the inverted list associated with the keyword into a plurality of segments; associating each segment with a different type entry; and for each type entry associated with a segment of the inverted list of the keyword, inserting a pointer to the segment.

17. A system comprising:
at least one computer memory, the at least one computer memory storing a computer program and a document retrieval index, the computer program configured to perform operations involving the document retrieval index when executed; and
processing apparatus coupled to the at least one computer memory, the processing apparatus configured to execute the computer program, wherein when the computer program is executed by the processing apparatus the system is configured to organize the document retrieval index by type and keyword entries; to organize the type entries by a type hierarchy comprising internal and leaf nodes; to determine whether to generate an inverted list for particular types depending on the position of the types in the type hierarchy; and to generate an inverted list for at least some of the types in the type hierarchy as a result of the determination.

18. The system of claim 17 further comprising:
a network interface configured to be coupled a network.

19. The system of claim 18 wherein the at least one computer memory, processing apparatus and network interface together comprise a server, the system further comprising:
a remote database accessible over the network, the remote database configured to store documents, wherein documents stored in the remote database are indexed in the document retrieval index.

20. The system of claim 18 wherein the computer program is further configured to receive type and keyword queries over the network and to use the document retrieval index to respond to the type and keyword queries.
